(19) United States
(12) Patent Application Publication
(10) Pub. No.: US 2026/0343137 A1
(43) Pub. Date: Oct. 29, 2026

(54) TRANSMISSION LINE SPEAKER ENCLOSURE

(71) Applicant: The Professional Monitor Company Limited, Biggleswade (GB)

(72) Inventors: Toby Thomas Oak Ridley, Biggleswade (GB); Oliver Alan Thomas, Biggleswade (GB)

(21) Appl. No.: 19/656,301

(22) Filed: Apr. 23, 2026

(30) Foreign Application Priority Data
Apr. 28, 2025 (GB) 2506392.6

(51) Int. Cl. H04R 1/28; H04R 1/02; H04R 31/00

(52) U.S. Cl. CPC H04R 1/2857; H04R 1/025; H04R 1/2803; H04R 31/00; H04R 2201/029

(57) ABSTRACT

A transmission line speaker enclosure includes a body having a first opening for fluid connection to a drive unit, a transmission line, a second opening for connection to a vent, and at least one acoustic resonator. The first opening is fluidly connected to the second opening via the transmission line. The at least one acoustic resonator comprises a chamber that is fluidly connected to the transmission line via an orifice. By utilizing acoustic resonators, the enclosure may attenuate unwanted sound frequencies without requiring acoustic foam or acoustic wadding, thereby improving recyclability of the speaker at end of life.

### CROSS-REFERENCE TO RELATED APPLICATIONS

This application claims priority to United Kingdom Patent Application GB2506392.6 filed at the United Kingdom Intellectual Property Office on Apr. 28, 2025 and titled “A Transmission Line Speaker Enclosure”, the entire contents of which are herein incorporated by reference as if fully set forth in this description.

### TECHNICAL FIELD

The present disclosure relates to a transmission line speaker enclosure. Aspects of the invention relate to a transmission line speaker enclosure, a transmission line speaker, a computer-implemented method for optimizing a transmission line speaker enclosure, and a method of manufacturing a transmission line speaker enclosure.

### BACKGROUND

A transmission line speaker makes use of its main quarter wave resonance of the transmission line to augment the bass response of a bass driver. Around the cabinet's resonance frequency, the air inside the cabinet becomes highly energized, leading to high air velocity at the transmission line vent and high pressure at the closed end of the transmission line. Since the driver is usually placed at the closed end of the line (or ⅓ along the line from the closed end), this has the effect of dramatically reducing driver excursion around these frequencies as the energized, high pressure air couples to the drive unit cone, adding mass and stiffness to the driver. Because of the natural delay between the action of the driver cone and the reaction at the transmission line vent, the vent air velocity is in phase with the cone velocity around the fundamental tuning frequency of the cabinet, causing the sound radiated from the vent to sum well with the sound radiated from the drive unit.

Unlike the Helmholtz resonance utilized in vented speakers, a transmission line doesn't just resonate at its fundamental tuning frequency, but also at odd multiples of this fundamental frequency. Unfortunately, because the exact tuning frequency of a transmission line is derived from a very complex list of parameters and not just the physical line length as it is often oversimplified to, the vent output at the higher harmonics will slide between being in phase and out of phase with the driver output, leading to a far field response that has cycling peaks and dips as the frequency increases.

There are several techniques that have been previously employed to reduce the negative impact from the higher harmonics of the transmission line, such as locating the drive unit ⅓ down the line from the closed end (this can completely cancel the 3rd harmonic from the vent output), tapering the line from the closed end towards the open end (which pushes the higher harmonics higher in frequency and lowers their amplitude), adding more folds to the transmission line (which also lowers the amplitude of the resonances) along with many more.

However, one common method is using carefully placed and specified acoustically absorbent foams that make use of porous absorption (through acoustic friction) to convert the higher frequency acoustic energy into heat. This can aid in controlling the upper harmonics by absorbing energy radiated from the drive unit into the transmission line at frequencies above the intended fundamental tuning frequency, thereby preventing the cabinet from being excited at any of the higher frequency harmonics.

Adding porous absorption to the transmission line causes several other acoustic effects beyond just the absorption of high frequency energy; because the foam absorbs acoustic energy by transforming it into heat energy, it changes the behavior of the acoustic system from adiabatic (where thermal energy is conserved) to isothermal. It so happens that the speed of sound in an isothermal acoustic system is slower than that of an adiabatic system, meaning that adding a significant amount of foam to a transmission line actually slows the speed of sound within the cabinet, leading to a lower fundamental resonant frequency for a given length of the transmission line.

The physical space taken up by the foam also slightly constricts the flow of air within the line, slightly mass-loading the system and further lowering the fundamental frequency of the transmission line, albeit at the cost of some overall system efficiency.

The addition of foam to a transmission line cabinet can dramatically increase the damping of the acoustic system, improving its time domain response and the subjective quality of its bass response. However, this effect is achieved up to a point, as it is easy to overdamp the system if excessive or improperly located foam is used. Overdamping the system may cause degradation in the acoustic fidelity if not mitigated.

It is therefore an aim of the present invention to overcome some of the drawbacks of prior transmission line speakers.

### SUMMARY

Aspects and embodiments of the invention provide a transmission line speaker enclosure, a transmission line speaker, a computer-implemented method, a computer program, a computer readable storage medium, a method of manufacturing a transmission line speaker enclosure, and a further method of manufacturing a transmission line speaker enclosure as claimed in the appended claims.

According to an aspect of the invention, there is provided a transmission line speaker enclosure, the enclosure comprising:
a body having a first opening for fluid connection to a drive unit, a transmission line, a second opening for connection to a vent, and at least one acoustic resonator,
the first opening being fluidly connected to the second opening via the transmission line, and
the at least one acoustic resonator comprises a chamber, wherein the chamber is fluidly connected to the transmission line via an orifice.

By providing the acoustic resonator connected to the transmission line the acoustic resonator can attenuate unwanted noise without the need for acoustic foam or acoustic wadding. The inventors have found through careful research that by utilizing the acoustic resonators within a speaker enclosure the resultant transmission line speaker performs substantially the same and in some cases better than transmission line speakers having acoustic foam.

Optionally, wherein the orifice of the acoustic resonator is positioned at a location along the transmission line, wherein the position corresponds to a pressure mode of a tuning frequency of the acoustic resonator.

Placing the orifice at the pressure mode of the tuning frequency of the acoustic resonator means that the acoustic resonator is best positioned to attenuate that sound frequency in the transmission line speaker in use. This is because the location of the orifice corresponds to the pressure mode on the speaker.

Optionally, wherein the body comprises a plurality of acoustic resonators and each of the plurality of acoustic resonators comprise a chamber, and wherein the chamber of each acoustic resonator is fluidly connected to the transmission line via an orifice of the acoustic resonator.

By utilizing a plurality of acoustic resonators, the magnitude and frequency bandwidth of the attenuation along the transmission line in practice can be increased.

Optionally, wherein each orifice of the plurality of acoustic resonator is positioned at a different location along the transmission line, wherein each position corresponds to a pressure mode of a tuning frequency of the respective acoustic resonator.

By utilizing a number of acoustic resonators tailored to specific tuning frequencies and located at the pressure mode of the tuning frequency a number of ‘problematic’ frequencies can be attenuated in practice.

Optionally, wherein the number of acoustic resonators is 2 to 20; or 2 to 15; or 2 to 10; or 2 to 8; or 2 to 6.

By providing multiple acoustic resonators the attenuating effect is increased.

Optionally, wherein one or more of the acoustic resonators are located on a first side of the transmission line and the rest of the plurality of acoustic resonators are located on a second side of the transmission line.

By packaging the acoustic resonators either side of the transmission line a number of effects may be obtained, for example this may aid with the packaging of the unit and reduces the overall footprint or volume of the unit itself. Moreover, by disposing the transmission line between the acoustic resonators the transmission line is further acoustically insulated from vibration of one or more of the outer walls of the body.

Optionally, wherein the at least one acoustic resonator is one of: a Helmholtz resonator or a quarter wave resonator or a tuned limp mass resonator, or a diaphragm resonator.

A Helmholtz resonator, quarter wave resonator, tuned limp mass resonator and diaphragm resonators are passive resonators meaning that they do not need to be powered to work.

Optionally, wherein the at least one acoustic resonator is configured to a tuning frequency of 50 to 550 Hz. Preferably wherein the tuning frequency is 100 to 500 Hz, more preferably 150 to 300 Hz.

Optionally, wherein the each of the acoustic resonators of the plurality of acoustic resonators may be configured to a different tuning frequency. By providing multiple acoustic resonators configured to different tuning frequencies a greater band width can be absorbed.

Optionally, wherein at least two of the tuning frequencies overlap; preferably wherein the at least two of the tuning frequencies overlap to combine and enable broadband absorption; and more preferably wherein the broadband absorption is between 50 Hz and 800 Hz. Optionally the broadband absorption is between 100 Hz and 700 Hz or 100 Hz to 600 Hz or 150 Hz to 500 Hz.

Optionally, wherein the chamber of the acoustic resonator is formed by a cavity of the body. By forming the chamber from a cavity of the body itself the body is more compact and results in a slimmer form factor.

Optionally, wherein the body is unitary. Providing a unitary body reduces the likelihood of leaks/gaps which may be present in a multi-part body.

Optionally, wherein the body has at least one planar side wall. Providing a planar side wall may provide a slimmer form-factor.

Optionally, wherein the at least one planar side wall has a recessed portion for receipt of one of: electrical cabling and a gasket.

The recessed cable routing means the cable can be routed along the wall and may not interfere with (or reduce interference with) the fluid dynamics of the interior of the speaker in use.

Optionally, wherein the at least one planar side wall has a plurality of mounting holes disposed around the planar side wall configured for receipt of a fixture. Having the mounting holes disposed on the planar side wall may simplify assemble as the planar side wall may be slid onto the fixtures.

Optionally, wherein the transition region between the transmission line and the orifice of the at least one acoustic resonator is rounded or tapered.

A rounded or tapered transition region may reduce the magnitude of the fluidic disruption experienced by air as it passes from the transmission line into the chamber or out of the chamber into the transmission line as compared to a sharp edge.

Optionally, the enclosure further comprising a drive unit mount and a vent; wherein the first opening is fluidly connected to the drive unit mount and the second opening is fluidly connected to the vent.

According to an additional aspect of the invention, there is provided a transmission line speaker comprising the transmission line speaker enclosure according to any embodiment of the aspect describing the transmission line speaker enclosure and a drive unit.

The transmission line speaker has the advantages of the enclosure which is incorporates.

Optionally, the transmission line does not contain an acoustic foam or acoustic wadding.

By not providing any acoustic foam in the transmission line of the speaker may be more easily recycled at the end of life.

Optionally, wherein the speaker enclosure does not contain an acoustic foam or acoustic wadding.

By not providing any acoustic foam in the speaker enclosure of the speaker may be more easily recycled at the end of life.

According to a further additional aspect of the invention, there is provided a computer-implemented method for optimizing a transmission line speaker enclosure, the method comprising the steps of:
receiving a first speaker enclosure geometry data comprising a body having a first opening for fluid connection to a drive unit, a transmission line, a second opening for connection to a vent, wherein the first opening is fluidly connected to the second opening via the transmission line;
determine one or both of a nearfield output and a far field output of the first speaker enclosure geometry data,
in response to determining the nearfield output and/or far field output determine a pressure peak location of a first tuning frequency of the first speaker enclosure geometry;
in response to the determination of the pressure peak location, determining a first orifice location for an orifice along the transmission line of an acoustic resonator configured to the first tuning frequency; and
output a second speaker enclosure geometry data comprising the first speaker enclosure geometry data and the first orifice location.

By optimizing the transmission line speaker enclosure in such a way there may be a reduced reliance on acoustic foam or acoustic wadding, or the need may be done away with entirely.

The nearfield output and far field output may be in dB (decibel).

Optionally, after determining the first orifice location for an orifice along the transmission line of an acoustic resonator configured to the first tuning frequency the method may comprise the step of displaying the first orifice location on a display screen.

Optionally, wherein the first speaker enclosure geometry data does not comprise data relating to an acoustic foam or acoustic wadding in one or more of: the body, the transmission line.

Optionally, the method may further comprise the step of determining and outputting one or both of a nearfield output and a far field output of the first speaker enclosure geometry data.

Outputting the nearfield and far field outputs enables the user to compare the results of the optimization with real world speakers.

The nearfield output and far field output may be a vent nearfield output and far field output or a drive unit nearfield output and far field output, optionally both the vent nearfield output and far field output and drive unit nearfield output and far field output may be obtained.

Optionally, the method may further comprise the step of determining and outputting one or both of a nearfield output and a far field output of the second speaker enclosure geometry data.

Outputting the nearfield and far field outputs may enable the user to compare the results of the optimization with real world speakers.

The nearfield output and far field output may be a vent nearfield output and far field output or a drive unit nearfield output and far field output, optionally both the vent nearfield output and far field output and drive unit nearfield output and far field output may be obtained.

Optionally, further comprising the steps of:
determining an additional pressure peak of an n^{th} tuning frequency of the second speaker enclosure geometry, where n is an odd number greater than 1;
in response to the determination of the additional pressure peak location, determining an additional orifice location for an orifice along the transmission line of an acoustic resonator configured to the n^{th} tuning frequency; and
wherein the second speaker enclosure geometry data further comprises the additional orifice location.

By optimizing the speaker enclosure geometry for multiple tuning frequencies multiple problem frequencies may be accounted for to improve the fidelity of the sound output of the speaker.

Optionally, wherein n=3 to 15, 3 to 13, 3 to 11, 3 to 9, 3 to 7, or 3 to 5.

Optionally, after determining the additional orifice location for an orifice along the transmission line of an acoustic resonator configured to the nth tuning frequency the method may comprise the step of displaying the nth orifice location on a display screen. Optionally, the first orifice location is displayed. Optionally, each orifice location is displayed.

Optionally the method may further comprise the steps of:
in response to determining the location of the additional orifice location, repeating the step to redetermine the pressure peak locations of the first tuning frequency to the n^{th} tuning frequency and determine whether the pressure peak location and additional pressure peak locations have moved,
in response to determining that any one of the pressure peak locations and additional pressure peak locations have moved updating and outputting the respective updated orifice location.

Optionally, after determining whether the pressure peak location and/or the additional pressure peak locations have moved displaying the respective updated orifice location(s).

Optionally, the method may further comprise the step of receiving a user input. The user input may comprise data relating to one or more of: the first speaker enclosure geometry data, an equivalent electrical circuit of a drive unit, a power of the drive unit, a resistance of the drive unit, the dimensions of the drive unit, a type of drive unit, a temperature of the simulation (e.g. room temperature), atmospheric pressure, a type of fluid model to be used (e.g. a linear elastic model), the frequencies being tested (e.g. 10 Hz to 1000 Hz), a step between frequency being tested (e.g. 10 Hz to 1000 Hz logarithmically spaced with 1 to 100 steps per decade), the volume of the domain being simulated and boundary conditions of the domain, the volume in dB of the soundwaves being tested.

Optionally, the method may further comprise a step of automatically transmitting the second speaker enclosure geometry data output to a server and/or user device for manufacturing the speaker. The user device may be an automated manufacturing system such as a CNC machine or a 3D printer. Such a step reduces the requirement for user interaction as the output may not be required to be manually reviewed prior to manufacturing.

According to a further aspect of the invention, there is provided a computer program comprising instructions which, when the program is executed by a computer, cause the computer to carry out the steps of the method according to any embodiment of the aspect directed to the computer-implemented method.

According to an even further aspect of the invention, there is provided a computer-readable storage medium comprising instructions which, when executed by a computer, cause the computer to carry out the steps of the method according to any embodiment of the aspect directed to the computer-implemented method.

According to a yet further aspect of the invention, there is provided a method of manufacturing a transmission line speaker enclosure according to the output of the computer-implemented method comprising the step of forming the transmission line speaker enclosure in dependence upon the output second speaker enclosure geometry data.

According to a yet even further aspect of the invention, there is provided a method of manufacturing a transmission line speaker enclosure according to any embodiment of the aspect describing a transmission speaker enclosure or any embodiment of the aspect describing a transmission line speaker, comprising the steps of:
forming a body having a first opening for fluid connection to a drive unit, a transmission line, a second opening for connection to a vent, and at least one acoustic resonator, the first opening being fluidly connected to the second opening via the transmission line, and the at least one acoustic resonator comprises a chamber, wherein the chamber is fluidly connected to the transmission line via an orifice.

Optionally, wherein the step of forming the body is undertaken by any one or combination of: a polymer extrusion process, a metal extrusion process, a 3D printing process, a casting process, a machining process, stacking a plurality of sheets.

Optionally, wherein the method further comprises providing at least one planar side wall, and the step of attaching the at least one planar side wall to the body.

### BRIEF DESCRIPTION OF THE FIGURES

FIG. 1A shows a schematic drawing of a transmission line speaker in accordance with an embodiment of the invention in an isometric view, the sidewalls of the speaker being see-through to show an internal arrangement of the transmission line speaker enclosure transmission line and acoustic resonators

FIG. 1B shows a partially cutaway view of the transmission line speaker of FIG. 1A.

FIG. 2 shows the transmission line speaker of FIG. 1B in a side-on view.

FIG. 3 is a schematic drawing of a computer configured to undertake a method in accordance with an embodiment of the invention.

FIG. 4 is a flowchart describing a method of optimizing a speaker geometry in accordance with an embodiment of the invention.

FIG. 5 is a flowchart describing a method of manufacturing a speaker enclosure.

FIG. 6 is a flowchart describing a method of manufacturing a speaker enclosure.

FIG. 7 shows a perspective view of a foamed transmission line speaker with the speaker enclosure partially cut away to show the transmission line and the acoustic foam.

FIG. 8A is a graph showing impedance for a foamless transmission line speaker and a foam transmission line speaker.

FIG. 8B is a graph showing Frequency vs measured sound pressure level (dB) for a 50 cm on axis between the drive unit and the measurement device for a foamless transmission line speaker and a foamed transmission line speaker.

FIG. 8C is a graph showing the frequency vs measured sound pressure level (dB) of the nearfield vent output for a foamless transmission line speaker and a foamed transmission line speaker.

FIG. 8D is a graph showing frequency vs measured sound pressure level (dB) for the nearfield woofer for a foamless transmission line speaker and a foamed transmission line speaker.

FIG. 9A is a graph showing the total sound pressure level vs frequency at the vent exit, 50 cm vent/woofer and the driver of a simulated foamless transmission line speaker, the simulated foamless transmission line speaker being simulated using the method of FIG. 4 using the computer of FIG. 3.

FIG. 9B is a graph showing graph showing the total sound pressure level vs frequency for the transmission line speaker of FIG. 1A at 50 cm on axis, the Nearfield vent and the Nearfield woofer for a foamless transmission line speaker.

### DETAILED DESCRIPTION

A transmission line speaker 10 and transmission line speaker enclosure 30 will now be described with the aid of the appended Figures. The transmission line speaker enclosure 30 comprises a number of acoustic resonators 50 that enables attenuation of soundwaves passing through the enclosure 30. By utilizing acoustic resonators 50 the total amount (e.g. volume, weight, etc. . . . ) of acoustic foam or acoustic wadding can be reduced in the transmission line speaker 10 or no acoustic foam and/or no acoustic wadding may be utilized or acoustic foam may be utilized in only specific regions of the speaker 10. As such, the attenuation of undesirable soundwaves may be achieved without the need to add acoustic foam or acoustic wadding.

The reduction or absence of acoustic foam in the transmission line speaker 10 means that the speaker 10 may be more environmentally friendly and easier to recycle than speakers containing acoustic foam. Acoustic foams or acoustic waddings may be hydrocarbon based, such as acoustic foams made from polyurethane or melamine or acoustic wadding made from fiberglass or polyester. Such acoustic foams or acoustic wadding may not be widely recycled in all locations, or may not be easy to recycle (such fiberglass acoustic insulation) leading to speakers containing acoustic foams ending up in landfill at the end of their useable life.

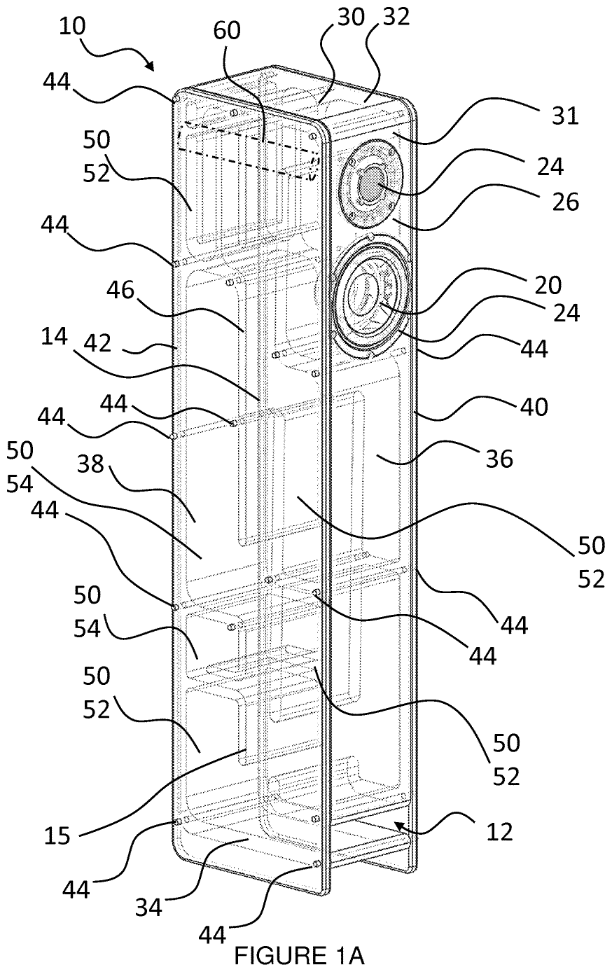

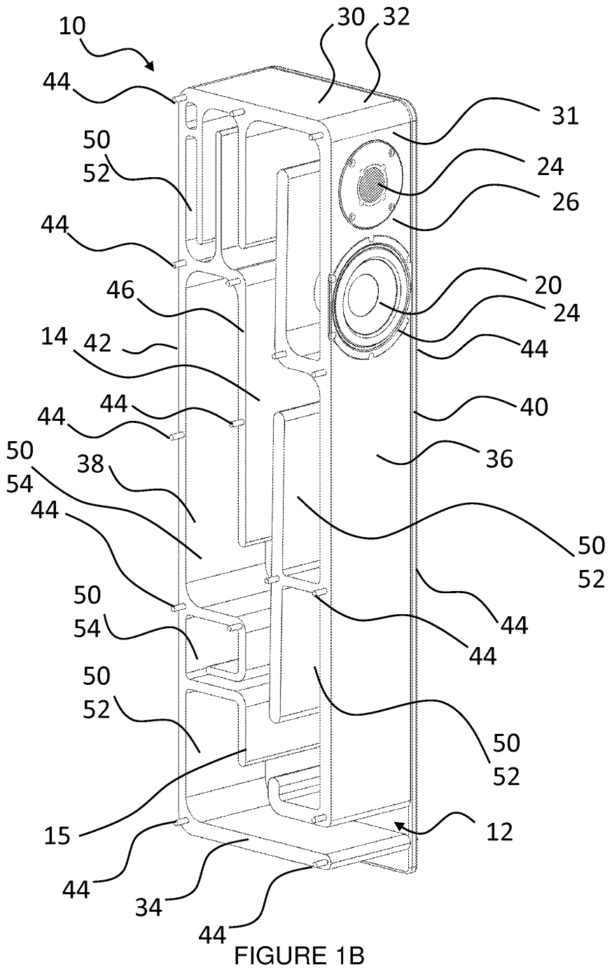

The transmission line speaker 10 is shown in FIG. 1A. The transmission line speaker 30 comprises a transmission line speaker enclosure 30 (also referred to as the ‘enclosure’ 30). The speaker 10 may be an active speaker or a passive speaker which may require external amplification.

The enclosure 30 is a unit defining an internal space. is shown as a substantially cuboid or ‘box-shaped’, however the enclosure may have any 3-dimensional shape, for example the enclosure 30 may be cylindrical, cuboid, cube, a prism, a rectangular prism, or any other suitable shape.

The depicted speaker enclosure 30 is substantially cuboid and has a top wall 32, a bottom wall 34, a front wall 36, a rear wall 38, a first side wall 40 and a second side wall 42.

One or more or all of the walls 32-42 may be removably connected to each other.

Optionally one or more of the walls 32-42 may be unitary with each other.

In the depicted example of FIG. 1A the top wall 32, bottom wall 34, front wall 36 and rear wall 38 are connected together to form a body 31. The body 31 may be unitary or it may be made up from two or more sections joined together to form the body 31.

Where the body 31 is unitary it may be cast, extruded, machined from a block of material or manufactured in an alternative method.

Optionally, the body 31 may comprise a number of sheets that are layered together to form the body.

The body 31 defines one or more internal walls 46 and passageways that form a part of the acoustic resonators 50 as will be described in more detail below.

One or both of the side walls 40, 42 are able to be disconnected to the body 31. This may enable the interior of the body 31 to be accessed for the purpose of cleaning. The side walls 40, 42 are connected to the body 31 via a plurality of fixtures 44. The fixtures 44 may be threaded fixtures such as bolts or screws or a grub screw. Each of the fixtures 44 may be complementary to a complementary fixture located on the body 31. The complementary fixture may be a bolt or threaded fixture embedded in the surface of the body 31.

The forward face has at least two apertures, a first aperture and a second aperture. The first aperture is provided above the second aperture.

The speaker 10 has one or more drive units 20, 24. In the depicted speaker 10 of FIG. 1A there are two drive units 20, 24. The first drive unit 20 is mounted onto the speaker enclosure 30 in the first aperture which is a drive unit mount 26. The first drive unit 20 is mounted via a drive unit mount 22 on the speaker enclosure 10. The first drive unit 20 has a front side and a rear side. The rear side faces the internal space provided the within the enclosure.

The speaker enclosure 30 has a port 12 (also known as vent 12), the port 12 is defined by the speaker enclosure 30. The port 12 is provided in the second aperture. The port 12 extends into the speaker enclosure 30.

The depicted speaker 10 of FIG. 1A has an optional third aperture that is a drive unit mount 26. The second drive unit 20 is mounted onto the speaker enclosure 30 in the third aperture. The second drive unit 24 is mounted via a drive unit mount 22 on the speaker enclosure 10. The second drive unit 24 has a front side and a rear side. The rear side faces the internal space provided the within the enclosure 30.

In alternative arrangements there may be a different number of apertures and drive units 20, 24 (such as one, two, three, four, five, six, etc.) and a different number of vents 12 (such as one, two, three, four, five, six, etc.). Whilst in the depicted example the drive units 20, 24 are shown on the forward face, they may alternately be located on any other face of the speaker, or arranged horizontally or diagonally, or where there are a plurality of drive units 20, 24 a subset of drive units (at least one of the total number of drive units) may be disposed on a first face and a second subset of drive units (at least one of the total number of drive units) is disposed on a second face. Whilst in the depicted example the vent 12 is shown on the forward face, the vent 12 (or vents 12) may alternately be located on any other face of the speaker, or arranged horizontally or diagonally, or a subset of vents (at least one of the total number of vents) may be disposed on a first face and a second subset of vents (at least one of the total number of vents) is disposed on a second face.

Optionally, the speaker 10 may have additional drive units mounted to the enclosure 30 in a similar fashion to the drive units 20 and optional drive unit 24.

The drive unit(s) 20, 24 may be any known drive unit in the art suitable for use in a transmission line speaker. For example, the drive unit may be selected from any one of the following examples which are known to the skilled reader: a tweeter, a super tweeter, a midrange drive unit, a mid-woofer, a woofer, a subwoofer, a mid-range driver, a bass speaker, a cone type drive, a dome type driver, a horn type driver, an open magnetic circuit driver, a closed magnetic circuit driver. The present disclosure may be utilized with any configuration or combination of drive units.

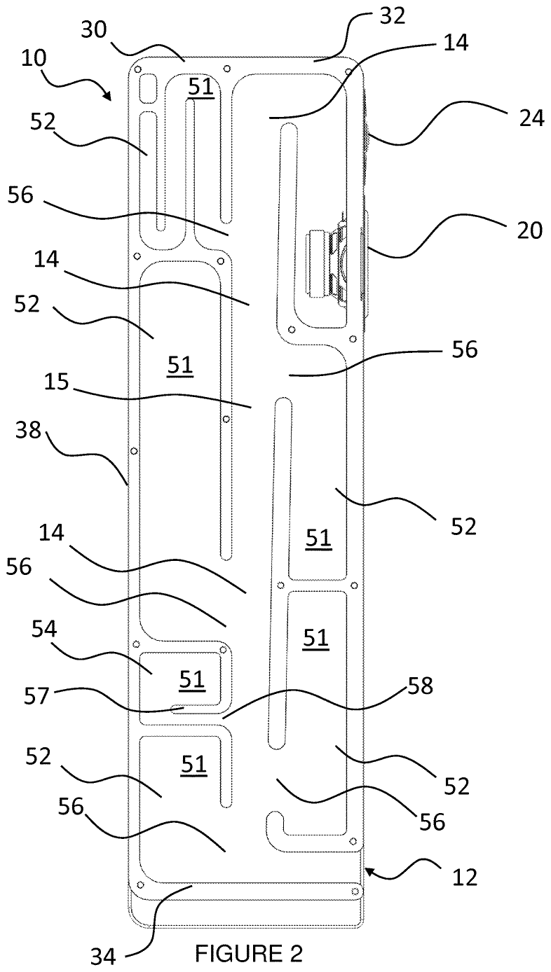

The speaker enclosure 30 has a damped pathway 14. The damped pathway 14 comprises a transmission line 15 that extends between the drive unit 20 and the port 12 as shown in FIGS. 1 and 2 and one or more acoustic resonators 50. The acoustic resonators 50 are fluidly connected to the transmission line 15.

The damped pathway 14 provides acoustic dampening by means of one or more acoustic resonators 50. The acoustic dampening enables the attenuation of sound from the drive unit 20

The damped pathway 14 may optionally further comprise one or more internal walls of the speaker enclosure 30 and/or one or more internal surfaces of the speaker enclosure 30 or and/or an acoustically absorbent material (such as a speaker acoustic foam as known in the art). For reasons of clarity acoustically absorbent material is not shown in the Figures however it may be incorporated into the speaker enclosure 30 by means and methods known to the skilled person.

Acoustic dampening may also be provided by the internal walls of the speaker enclosure 30 which reduce acoustic bleed through the walls of the speaker 10 which may be heard by user when listening to audio output from the drive unit(s) 20, 24.

The drive unit 20 is fluidly connected to the port 12 via the damped pathway 14. In use, pressurized air from the rear side of the drive unit 20 passes through the damped pathway 14 and out through the port 12 into the atmosphere surrounding the speaker 10. This side of the drive unit 20 is not normally visible in use.

The front and rear of the drive unit 20 may be substantially fluidly isolated from each other to reduce the likelihood of interference between soundwaves being produced from the front of the drive unit 20 and the rear of the drive unit 20. The fluid isolation may be achieved by means and methods known in the art when mounting the drive unit 20 to the drive unit mount 22.

Where there is a second drive unit 24 (as in the depicted speaker 10 in FIG. 1A) this may also be connected to the damped pathway 14 such that the damped pathway extends between the drive unit 20 and the port 12. If additional drive units are present, they may likewise be connected to the damped pathway 14 in a similar manner.

The speaker 10 may have a controller or electric circuit board that is configured to control one or more drive units 20, 24. The controller or electric circuit board may be electrically connected to one or more drive units 20, 24 by electrical wiring or electrical cabling. The controller or electric circuit board may be one known in the art. The controller or electric circuit board are not shown in FIG. 1A but may be located in a section of the enclosure 30 such as a recessed section 60. The recessed section may be covered by a covering such as a plate or door to enable access to the controller or electric circuit board as required by the user.

Electrical wiring or electrical cabling may be routed through the enclosure 30 along recessed portion 60 which is represented by dot-dashed lines in FIG. 1A. The recessed portion 60 may be in any appropriate location to route wiring or cabling through the enclosure. As will be appreciated the recessed portion 60 is shown as a substantially cylindrical section however the recessed portion 60 may be any conceivable shape and the cylindrical section is provided for the purpose of teaching the invention. For example, the recessed portion 60 may have a tortuous path that follows one or more internal walls of the enclosure 30 (either internally or along a surface of said internal wall). In alternative configurations there may be no recessed portion 60 and the wiring or cabling may be disposed on or in a portion of a fluid path of the enclosure 30.

The acoustic resonators 50 will now be described in more detail. The acoustic resonators 50 are shown in FIGS. 1 to 2. The acoustic resonators 50 are fluidly connected to the damped pathway 14. Each acoustic resonator 50 comprises a chamber 51 that is connected to the transmission line 15 via an orifice 56, 58. The orifice 56, 58 enables the movement of fluid into and out of the chamber 51.

The chamber 51 is formed from a number of chamber walls. At least one of the chamber walls may be internal walls of the body 32 as in the depicted enclosure 30 in FIGS. 1 to 2. In such a case the chamber walls may be unitary with the body 32. Optionally one or two of the chamber walls may be formed of a section of the first or second side wall 40, 42. Alternatively, the chamber 51 may be formed entirely within the body 32 such that the chamber walls are formed entirely by one or more of the internal walls of the body 32.

The acoustic resonators 50 may be a quarter wave resonator 52 or a Helmholtz resonator 54 or a tuned limp mass resonator or a diaphragm resonator.

The tuned limp mass resonator, diaphragm resonator may be located in a chamber 51 connected to the transmission line 15 via the orifice 56, 58.

The enclosure 30 shown in FIGS. 1 to 2 has five quarter wave resonator 52 and one Helmholtz resonator 54.

A Helmholtz resonator 54 functions by using a chamber 51 of a specific volume, attached to a neck 51 with a specific cross-sectional area and length. The relative masses of air in the neck 57 and chamber 51 create an acoustic analogy of a mass on a spring, with the mass of air in the neck acting as the mass, and the compliance of the air in the chamber acting as the spring force.

The resonant frequency of a Helmholtz resonator 54 is increased by either decreasing the neck 57 length, increasing the neck 57 surface area, or decreasing the chamber 51 volume. Whilst this means that the same resonant frequency can be achieved by various different ratios of the three variables, there are some ratios that can negatively affect the efficiency of the resonance; a very narrow neck will give a much less efficient resonance than a wider neck at the same tuning frequency (also referred to as the ‘resonant frequency’). Likewise, a smaller chamber 51 will give a weaker resonance than a large chamber. Differences in the three variables will also alter the quality factor (Q) of the Helmholtz resonance, so depending on the set of compromises you choose, it is possible to achieve quite a spread in measured responses from Helmholtz resonators with the same theoretical tuning frequency.

A simplified formula for calculating Helmholtz resonant frequency (no accounting for end correction) is provided by:

$$Resonant Frequency = \frac{c}{2 π} \cdot \sqrt{\frac{S}{V \cdot {L}_{n}}} \qquad ( 1 )$$

Where:
c=Speed of sound (343 m/s)
S=Neck surface area (m²)
V=Chamber volume (m³)
Ln=Neck length (m)

Quarter wave resonators 42 make use of a pipe resonance whereby a standing wave is formed along the length of the resonator 42 when the resonator 42 is excited by acoustic pressure at a frequency whose wavelength corresponds to four times the length of the pipe. Odd multiples of this fundamental frequency will also excite harmonics of the initial pipe resonance, meaning that unlike a Helmholtz resonator, a quarter wave resonator will absorb more than one frequency. The efficiency of the absorption that a quarter wave resonator can achieve decreases at higher harmonics, but a significant amount of absorption can still be achieved at high frequencies.

As with a Helmholtz resonator 54, there are several variables that can affect the efficiency and behavior of a quarter wave resonator 52 beyond just the pipe length controlling the fundamental tuning frequency (also referred to as the ‘resonant frequency’). Increasing the cross-sectional area of the resonator will increase the efficiency of the absorption, whilst introducing a taper along the length of the pipe will artificially lower the tuning frequency, whilst also decreasing the efficiency slightly but also lowering the quality factor (Q) of the resonance. As a quarter wave resonator 52 also resonates at odd multiples of its fundamental frequency, by arraying a suitable set of quarter wave resonators with offset tuning frequencies, it is possible to achieve a relatively smooth broadband absorption by covering only a single octave with overlapping absorption efficiency peaks.

Simplified formula for calculating the fundamental resonant frequency of a quarter wave resonator (not accounting for end correction, bends, tapers etc) is provided by the following equation:

$$Resonant Frequency = \frac{c}{4 L} \qquad ( 2 )$$

Where:
c=Speed of sound (343 m/s)
L=Resonator length (m)

The resonators 50 may be placed along the transmission line 15 such that their orifice 56, 58 corresponds to a position where a pressure peak occurs along the transmission line 15. The pressure peak being an undesirable resonant peak of the transmission line 15 which may cause unwanted degradation of audible quality in use.

The location of the pressure peaks may be found by calculating the fundamental resonant frequency (the tuning frequency) of the transmission line 15 which is found by assuming that the transmission line is a quarter wave resonator using equation (2) above. A transmission line 15 also resonates at odd multiples of its fundamental resonant frequency, i.e. where n=1, 3, 5, 7 . . . and each resonant frequency can be found from the equation:

Rf=nf (3)
Where:
Rf is the resonant frequency (Hz)
n is an odd number
f is the fundamental resonant frequency of the transmission line 15 (Hz).

By finding the position of the peaks in relation to the wave source (the rear of the drive unit 20) which is located at the closed end of the transmission line 15. The open end of the transmission line 15 opens to the port 12. This transmission line 15 is shown in FIGS. 1A, 1B and 2 extending between the closed end with the drive unit 20 and the port 12.

The wavelength can be obtained from the well-known formula:

λ=c/f (4)
Where:
λ is the wavelength of the wave (m)
c is the speed of sound travelling through a medium (m/s)
f is the frequency (Hz)
c may be 343 m/s for sound traveling through air.

The pressure peaks will be located at positions on the wave corresponding to peaks on the waveform. As will be apparent from equation (3) some peaks are shared by multiple resonant frequencies. For example, where the first resonant frequency has a wavelength of 4 meters (n=1), the third resonant frequency will have a wavelength of 1.333 meters which will have a peak in phase with the first resonant frequency.

As can be seen in FIGS. 2, 3 and 4 the acoustic resonators 50 open to the transmission line 15 at various positions along the length of the transmission line 15. The location of these openings, or orifices 56, 58 correspond to the locations of the pressure peaks.

The location of these pressure peaks may be modelled through the means of finite element analysis or computerized fluid simulation of the speaker 10. This may be particularly advantageous to optimize the location of the acoustic resonators 50 on the transmission line 15.

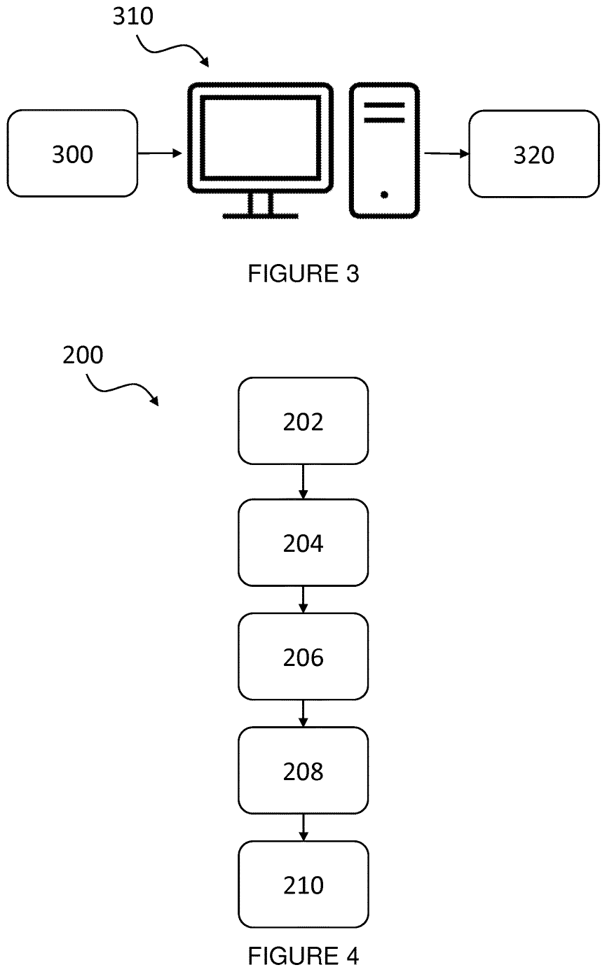

A computer-implemented method 200 for optimizing a transmission line speaker enclosure 30 will now be described with the aid of FIGS. 3 and 4. The method 200 is used to optimize any of the previously described transmission line speaker enclosures 30. The method 300 is used to optimize the location of the acoustic resonators 50 in the transmission line enclosures 30. The method is represented by flowchart 200 in FIG. 4. Flowchart 200 comprises a number of steps. The method is particularly useful for optimizing the transmission line speaker 30 to reduce or negate the requirement for acoustic foam or acoustic wadding in the transmission line 14.

The method 200 is implemented in a computer 310 as shown in FIG. 3 and may be undertaken using a computational fluid dynamics software suit, for example Fluent™, Ansys™, or a proprietary modelling suit such as using COMSOL™, MATLAB™, C++ or FORTRAN or alternative computing language as known in the art. The method 400 may be undertaken either using a single computer or utilizing a distributed computing system. The computer 310 receives one or more inputs 300 including a speaker enclosure geometry data. The inputs 300 may be entered into memory of the computer 310 by manual means (e.g. data entry by the user) or they may be loaded from a stored memory device or computer readable medium or memory. The memory may be a transitory memory. For example, the inputs 300 may be stored in and retrieved from a database.

The speaker enclosure geometry data can comprise anyone or more of: the internal volume of the speaker, the length from drive unit 20 to the port 12, the dimensions of the enclosure 30, the length of the transmission line 14, the shape of the transmission line 14, the material that the speaker enclosure 30 is made from, the dimensions of the drive unit 20, the speed of sound in said material, the density of said material, other materials parameters of the speaker enclosure 30, the absorption coefficient of the said materials. The speaker enclosure geometry data may comprise any dimension of any previously described part of a speaker 10 or a speaker enclosure 30.

Additionally, the inputs 310 may comprise data relating to one or more of: the equivalent electrical circuit of a drive unit 20 utilized in the simulation, the power of the drive unit 20, the resistance of the drive unit, the dimensions of the drive unit 20, the type of drive unit 20, the temperature of the simulation (e.g. room temperature), the atmospheric pressure, the type of fluid model to be used (e.g. a linear elastic model), the frequencies being tested (e.g. 10 Hz to 1000 Hz), a step between frequency being tested (e.g. 10 Hz to 1000 Hz logarithmically spaced with 1 to 100 steps per decade), the volume of the domain being simulated and boundary conditions of the domain, the volume in dB of the soundwaves being tested.

Additional inputs or different inputs 310 may be utilized by the skilled reader as called for by the computational method they chose to implement the present teaching in.

The computer outputs output 320, the output 320 may be an output to a display of the computer or a printout or other means of displaying the value or a 3D model of the transmission line speaker enclosure 30. The output 320 is for use in optimizing and manufacturing a speaker according to the output. Preferably, the output 320 is for use in optimizing and manufacturing a speaker according to the output to reduce unwanted noise at or adjacent to the port.

Whilst FIG. 3 shows the computer 310 as a desktop computer this is purely for explaining the invention. Computer 310 may be a terminal, distributed computing device, a laptop, a server, or any other suitable computing device 310.

Whilst the previous method for placing the acoustic resonators 50 on the transmission line is suitable by calculating the location of the pressure peaks, for optimizing the location and providing the greatest attenuation it may be advantageous to remodel the system iteratively every time a new acoustic resonator 50 is added. As the addition of an acoustic resonator 50 can affect the fluid dynamics of the transmission line 15 it may be useful to understand whether it has been placed in the optimal location. Similarly adding a second or further acoustic resonator 50 can likewise affect the fluid dynamics of the transmission line 15, therefore it may be advantageous to move the orifice 56, 58 of the prior acoustic resonator(s) 50 to compensate. Such iterative changes whilst having marginal gains to acoustic quality produce a higher fidelity speaker 10.

The flowchart 200 describes a number of steps for optimizing a transmission line speaker enclosure 30. At step 210 a first speaker enclosure geometry data is received by the computer 310. The first speaker enclosure geometry data comprises geometry data describing a body having a first opening for fluid connection to a drive unit, a transmission line, a second opening for connection to a vent, wherein the first opening is fluidly connected to the second opening via the transmission line is received. The first speaker enclosure geometry data may comprise additional data as described above with respect to inputs 310.

The first speaker enclosure geometry data may be stored on a transitory memory means in the computer 310. The first speaker enclosure geometry data may be a 2D speaker enclosure geometry or a 3D speaker enclosure geometry.

Where the first speaker enclosure geometry data is 2D the simulation is a 2D simulation. Running the simulation as a 2D simulation may increase the processing speed of the simulation as there are relatively fewer data points which would need to be resolved each time step as compared to a 3D simulation comprising a plurality of voxels representing a single x, y, z coordinate.

Where the first speaker enclosure geometry data is 3D the simulation is a 3D simulation or alternatively a 2D slice through the 3D simulation may be obtained to undertake a 2D simulation. The 2D slice may be a cross-sectional slice through the first speaker enclosure geometry as in FIGS. 2-4 or similar to FIGS. 2-4.

The simulation (2D or 3D) may optionally be a finite element analysis or computerized fluid simulation of the speaker enclosure geometry data.

A 3D simulation may provide greater depth of understanding to the user of the method as compared to a 2D simulation.

Subsequently, at step 204 the computer 310 determines one or both of a nearfield vent output and a far field response of the first speaker enclosure. The near field vent output is obtained at or adjacent to or in the port 12 of the simulated transmission line speaker enclosure 30 and/or at or adjacent to the drive unit 20.

The far field response is obtained at a point in the simulated area which is spaced apart from the port 12 and may be for example 0.5 to 10 meters from the port 12 in the simulated area.

At step 206 the computer 310 determines a pressure peak of a first tuning frequency of the first speaker enclosure geometry. The pressure peak of the first tuning frequency may be obtained from the determination of the nearfield output and/or far field output at step 204.

Subsequently, at step 208 in response to the determination of the pressure peak the method determines a first orifice location for an orifice along the transmission line of an acoustic resonator configured to the first tuning frequency.

The location of the pressure peak(s) may optionally be determined through the means of finite element analysis or computerized fluid simulation of the first speaker enclosure geometry.

Then at step 210 the computer 310 outputs a second speaker enclosure geometry data comprising the first speaker enclosure geometry data and the first orifice location. The second speaker enclosure geometry may optionally further comprise data relating to the geometry of an acoustic resonator that is connected to the transmission line via the first orifice. The acoustic resonator may be any previously described acoustic resonator.

The output 210 may be displayed to the user as previously discussed or exportable to a program for manufacturing a speaker enclosure or viewing the speaker enclosure, such as a CAD file or .stp file or other suitable file format.

The output 210 may be readable by proprietary software such as CNC machining software suite configured to instruct a CNC machine to machine a feedstock material to form the speaker enclosure 30 or a part thereof, or a 3D printer software suite configured to instruct a 3D printer to form a speaker enclosure 30 or a part thereof.

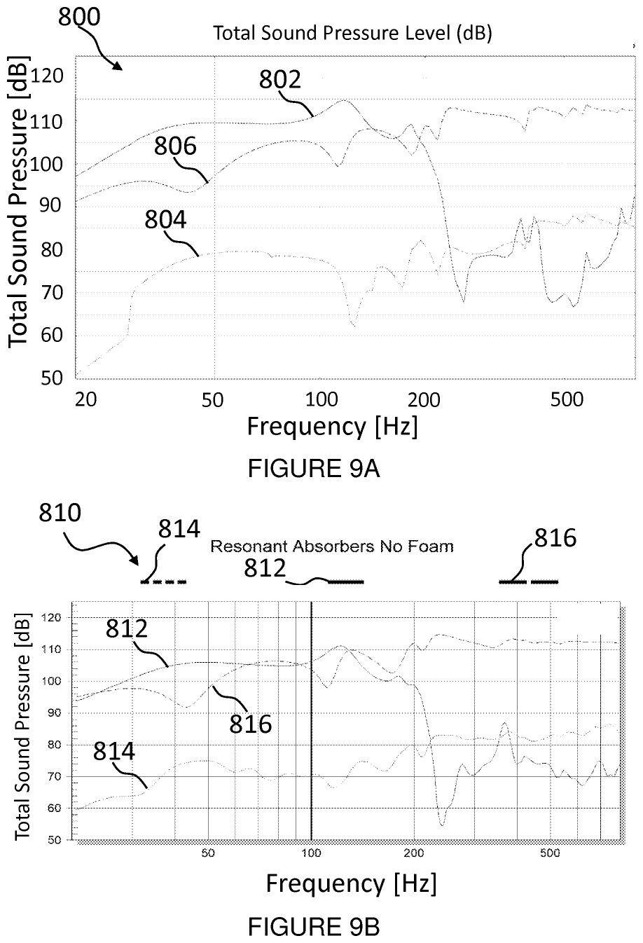

Optionally, the output 210 may further comprise data relating to the sound pressure level at one or more of the nearfield vent, nearfield speaker and a distance away from the vent 12. The distance may be 0.1 m to 1 m, preferably the distance is 0.5 m. Such an output is shown in FIG. 9A which plots the simulated sound pressure level in dB against the frequency (Hz).

Optionally, the method 200 may comprise additional steps to determine the location of other pressure peaks in the second speaker enclosure and therefore determine the placement of one or more additional orifices for additional acoustic resonators 50. These optional additional steps may come between steps 208 and 210 or after the output 210 has been made.

Firstly, one or both of a nearfield vent output and a far field response of the second speaker enclosure geometry data is simulated in dependence upon the previously obtained second speaker enclosure geometry data and the location of the first orifice.

Next the method determines in response to the simulation step a pressure peak location of an n^{th} tuning frequency of the second speaker enclosure geometry, where n is an odd number greater than 1. “n” may be for example, 3, 5, 7, 9, 11, etc. . . . As will be understood from careful reading of the above description in relation to the resonant frequencies it is the odd-multiples of the fundamental resonant frequency (tuning frequency) of the transmission line 15 which may cause acoustic degradation due to air inside the cabinet becoming highly energized, leading to high air velocity at the transmission line vent and high pressure at the closed end of the transmission line.

Subsequently, in response to the determination of the pressure peak location determine an additional orifice location for an orifice along the transmission line of an acoustic resonator configured to the n^{th} tuning frequency.

The second speaker enclosure geometry data is then updated to further comprise the additional orifice location. The additional orifice location corresponds to the opening of an additional acoustic resonator 50. The second speaker enclosure geometry may optionally further comprise data relating to the geometry of an acoustic resonator that is connected to the transmission line via the additional orifice. The acoustic resonator 50 may be any previously described acoustic resonator and the size of the acoustic resonator 50 may be determined using the equations above and taking into consideration the available space in the body of the second speaker enclosure geometry.

The location of multiple pressure peaks may be determined using such a method. For example, the pressure peak locations of the 1^{st}, 3^{rd}, 5^{th}, 7^{th}, 9^{th}, etc may be obtained. As will be apparent to the skilled reader higher frequency resonant frequencies (tuning frequencies) may have more than one pressure peak location along the length of the transmission line as the wavelength of high frequency sound waves is shorter compared to lower frequency sound waves. As such, some tuning frequencies may have two, or more pressure peak locations along the transmission line.

The location of these pressure peaks may optionally be determined through the means of finite element analysis or computerized fluid simulation.

As will also be apparent, where the resonant frequency results in a pressure peak location which is in a location beyond the transmission line 15, i.e. passed the port 12, these may not be compensated by the inclusion of acoustic resonators 50 unless there is an earlier pressure peak (i.e. on the transmission line 15) which could be accounted.

Optionally, the method may be repeated to optimize the output second speaker enclosure geometry. By adding an orifice and resonant absorber 50 configured to attenuate a certain frequency this may change the fluid dynamics of the transmission line 15 itself. As such, it may be useful to re-simulate the second speaker enclosure geometry to determine if one or more of the pressure peaks has moved. If one or more of the pressure peaks has moved then the respective orifice location assigned to that pressure peak may be updated and output at step 210.

Such an optional step may be repeated a number of times to iteratively utilize the previous loops output second speaker enclosure geometry to determine the subsequent loop's. For example, 2 to 10 or more times, or until there is no change in the location of the pressure peaks or where the change in the location of the pressure peaks has substantially not changed between iterations (for example between 0 to 20 mm change in location).

The location of these pressure peaks may optionally be determined during each iteration through the means of finite element analysis or computerized fluid simulation of the first speaker enclosure geometry.

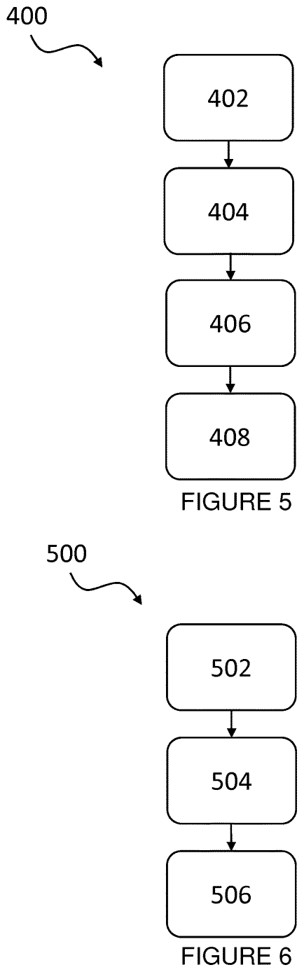

A first method 400 of manufacturing the speaker enclosure 30 according to the output 210 of the computer-implemented method or according to any previously described speaker enclosure 30 will now be described. The method 400 is shown by flowchart 400 comprising method steps in FIG. 5.

At step 402 the output 210 of the computer-implemented method 200 is obtained.

Subsequently at step 404 a speaker enclosure 30 is formed in dependence upon the output 210.

The step of manufacturing the speaker enclosure 404 may comprise manufacturing the speaker enclosure 30 to the second speaker geometry data. The step of manufacturing the speaker enclosure may comprise forming the speaker enclosure 30 in dependence upon the output second speaker enclosure data that comprises geometry data describing a body having a first opening for fluid connection to a drive unit, a transmission line, a second opening for connection to a vent, wherein the first opening is fluidly connected to the second opening via the transmission line, and the orifice location(s) of the one or more orifices determined by the method 200.

Where the output 210 of the method is a 2D speaker geometry the method may include the step of determining an enclosure width (an enclosure depth and height would be known from the output 210). The enclosure width may be obtained by multiplying the diameter of a drive unit 20, 24 (e.g. the widest point of the speaker where it connects to the enclosure 30) by 1.1 to 2 or more. By doing so this will take into account the drive unit mount 22, 26 of the drive unit. Alternatively, the enclosure width may be any value chosen by the user that is greater than the diameter of the drive unit 20, 24 or the greater than the diameter of the largest drive unit 20, 24 where there are more than one drive units 20, 24 placed above-and-below relative to each other as in FIG. 1A. Other configurations are conceivable however, for example where the drive units 20, 24 are disposed side-by-side or in other arrangements the enclosure width may be sufficient to enable the drive unit 20, 24 to be mounted.

A second method 500 of manufacturing a speaker enclosure 30 according to any previously described speaker enclosure 30 is also described by flow chart 500 and FIG. 6.

The method 500 comprises the step 502 of forming a body 32 having a first opening for fluid connection to a drive unit 20, a transmission line 15, a second opening for connection to a vent 12, and at least one acoustic resonator 50, the first opening being fluidly connected to the second opening via the transmission line, and the at least one acoustic resonator comprises a chamber, wherein the chamber is fluidly connected to the transmission line via an orifice.

According to either the first or second methods of manufacturing a speaker enclosure 30 additional steps may be provided, for example:

The step of manufacturing may further comprise forming an acoustic resonator 50 in the body of the speaker enclosure 30 that corresponds to the tuning frequency(s) and the orifice location. For example, the step of manufacturing may comprise forming a quarter wave resonator 52 corresponding to the tuning frequency, or a Helmholtz resonator 54 corresponding to the tuning frequency.

The step of manufacturing may comprise the step of forming a body 32 having a first opening for fluid connection to a drive unit 20, a transmission line 15, a second opening for connection to a vent 12, and at least one acoustic resonator 50, the first opening being fluidly connected to the second opening via the transmission line, and the at least one acoustic resonator comprises a chamber, wherein the chamber is fluidly connected to the transmission line via an orifice.

The body may be made from a polymer, a polymer blend, or plurality of polymers/polymer blends. The polymer(s) may be a thermoset or thermoplastic polymer. The polymer may be any one of, combination of, or blend of: polyethylene (PE), polycarbonate (PC), and polyvinylchloride (PVC), polypropylene (PP), polystyrene (PS), and polyethylene theraphthalate (PET), a resin, an epoxy resin, a phenolic resin, a melamine, a polyurethane, a polyester, silicone, a UV curable polymer, a photosensitive polymer.

The body may be made from a wooden material or an engineered wood. The wooden material or engineered wood may be in the form of a sheet or laminated sheet or plurality of sheets or laminated sheets. The body may be formed by stacking a plurality of sheets or may be milled from one or more blocks of wooden material or engineered wood.

The body may be made from a metal or alloy. The alloy may be a ferrous or non-ferrous alloy. The alloy may be an aluminum alloy, an iron alloy, a titanium alloy, or any other suitable alloy.

The step of forming the body 404, 502 may be undertaking using one or more processes represented by optional step 406 and optional step 504 respectively. The step 406, 504 may comprise for example any one or combination of: polymer extrusion process, a metal extrusion process, a 3D printing process, a casting process, a machining process, stacking a plurality of sheets.

The polymer extrusion process may be one where the body is formed by forcing a melted polymer/polymer blend/mixture of polymers through a die configured to form the body. The body may have a constant cross-section. The extruded material forms the body as it is extruded from the polymer extrusion machine. The polymer may be selected from any previously described polymer, polymer blend or plurality of polymers/polymer blends or any other suitable polymer-based material.

The metal extrusion process may be one where the body is formed by forcing a metal or alloy through a die with a cross-section configured to form the body. The metal or alloy may be molten and may solidify as it passes through the die.

The 3D printing process may be a polymer 3D printing process or a metal 3D printing process. The 3D printing process may be selected in dependence upon the material the skilled reader would like to make the body from as is known in the art. For example, for an alloy body selective laser sintering may be a more suitable process than stereolithography for example. The 3D printing process may be any one of selective laser sintering, fused deposition modelling, polyjet, multi jet fusion, direct metal laser sintering, electron beam melting, stereolithography, digital light process or any other suitable 3D printing process known in the art.

Where stereolithography or digital light process 3D printing techniques are utilized the polymer may be a UV-curable or photosensitive polymer.

The casting process may be a metal casting process such as die casting (hot die casting or cold die casting), investment casting, lost wax casting, lost foam casting, and sand casting. The casting process may be a polymer or resin casting process whereby liquid polymer or resin is poured into a mold or die.

The machining process may be one whereby the body 32 is formed by machining the body 32 from a block of starting material. The block of starting material may be a block of any previously described material (e.g. polymer, wooden material, engineered wood, metal or alloy, etc). The block of starting material is formed into the body by removal of material, for example by any one or more of: a drilling, milling, routing and electron discharge machining operation, or any other suitable operation.

The body 32 may be formed by stacking a plurality of sheets. By stacking a plurality of sheets, such as a stack of machined engineered wood sheets, the body may be formed. The stacking of sheets enables the sheets to be made separately and then assembled together. As a result conventional sheet cutting or machining operations can be utilized. For example the sheet may be machined or cut utilizing any one of: a water-jet, laser cut, or a CNC milling machine. The individual sheets may then be stacked together to form the body 32.

The method of manufacturing the speaker enclosure 30 may comprise the step of not adding an acoustic form to the speaker enclosure 30 transmission line 15, or not adding any acoustic foam to any interior volume of the speaker enclosure 30.

Optionally, in order to close the body 32 which if during manufacturing leaves one or more open side faces as a result of the manufacturing process may comprise an additional optional step to close the body 32. This step is represented by optional step 408 and optional step 506. At step 408, 506 comprises providing at least one planar side wall, and the step of attaching the at least one planar side wall to the body 32. The at least one planar side wall may be attached to the enclosure 30 by means of one or more fixtures 44.

The at least one planar side wall may be removable to enable access to internal volumes of the speaker enclosure 30 for installation of electronics and/or other components when making a speaker.

The speaker enclosure 30 may have a gasket or seal inserted between the planar side wall and the speaker enclosure 30 body 32.

### Example of Acoustic Measurements of Speaker 10

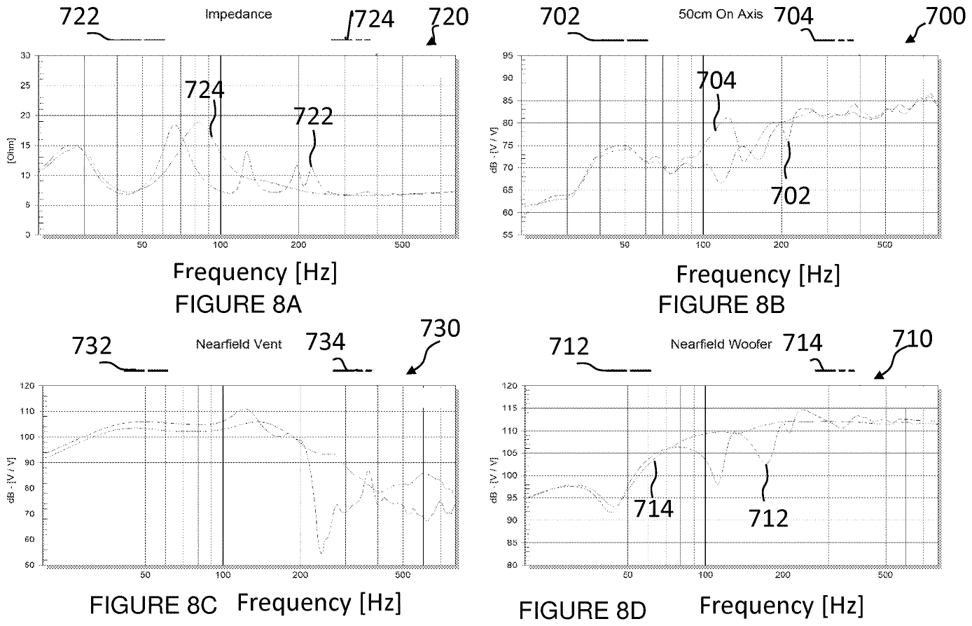

FIGS. 8A-8D show a number of graphs 700, 710, 720, 730 with traces 702, 712, 722, 732 comparing acoustic measurements of a speaker 10 incorporating the speaker enclosure 30 produced using the computer implemented method and manufactured using the first or second manufacturing methods 200, 400, 500. The speaker 10 which has been used to produce these graphs 700, 710, 720, 730 and traces 702, 712, 722, 732 does not contain any acoustic foam.

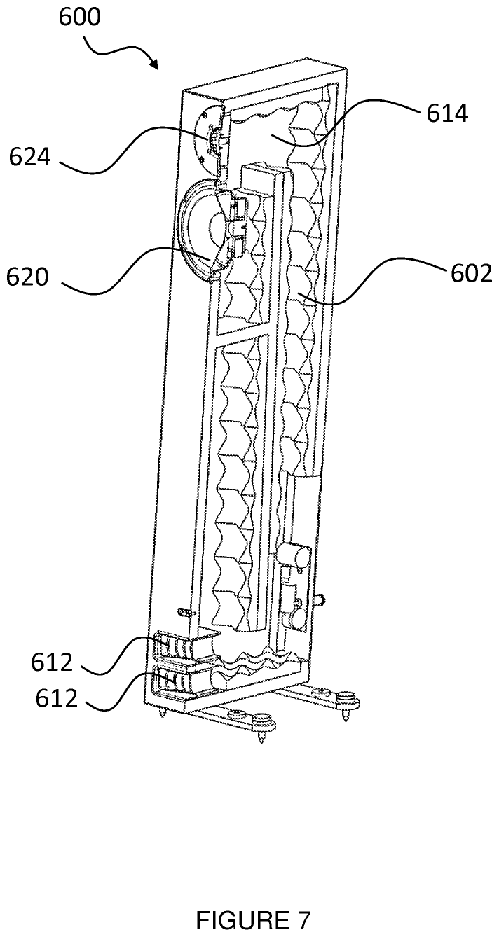

The FIGS. 8A-8D show acoustic measurements of the speaker 10 and compare them to a reference transmission line speaker 600 which has the same geometry (i.e. speaker cabinet shape and dimensions, a substantially same transmission line 614 as the previously described transmission line 14, a port 612 substantially the same as port 12, and drive units 620, 624 which are the same as drive units 20, 24). The reference transmission line speaker is shown schematically in FIG. 7. This reference transmission line speaker 600 does not have any acoustic resonators. The reference transmission line speaker 600 contains acoustic foam 602 and/or acoustic wadding 602. The reference transmission line speaker 600 has a vent offset one third along the transmission line instead of directly at the end, this offset is a constituent part of the transmission line.

The measurements for the reference transmission line speaker 600 are represented on graphs 700, 710, 720, 730 by traces 704, 714, 724, 734.

Both the transmission line speaker 10 and the reference transmission line speaker 600 utilized the same drive units 20, 24 and were tested in substantially the same conditions.

The transmission line speaker 10 and reference transmission line speaker 600 were both measured, in turn, by suspending them approximately 60 cm above the floor of a semi-anechoic chamber with the drive units facing upwards (the speaker resting on its back across two speaker stands). A 1 V (Volt) RMS (Root Mean Square) swept sine wave test signal (20 Hz-20 kHz) was input to the speaker terminals, and a calibrated measurement microphone was used to record the acoustic response of the loudspeaker. The test was repeated with the microphone located nearfield to the vent output, nearfield to the drive unit and 50 cm on axis between the vent and the drive unit. The electrical impedance at the loudspeaker terminals was also recorded using diagnostic audio measurement equipment from Kippel GmbH.

From these measurements it can be seen that the absorption of the vent 12 output above 150 Hz in the speaker 10 significantly exceeds that of the reference transmission line speaker 600 up to nearly 2 kHz (around the crossover region for this speaker 10), whilst also showing a more efficient fundamental transmission line resonance.

The increased low frequency efficiency can also be seen in the 50 cm on axis measurement, where a 1-2 dB gain can be seen below 70 Hz vs the reference transmission line speaker 600. The fundamental resonant frequency of the speaker 10 closely matches that of the reference transmission line speaker 600. This shows that the simulations undertaken by finite element analysis using the method 200 (FIG. 9A) accurately predicted the speaker 10 response (shown in FIG. 9B for ease of comparison with FIG. 9A which shows the simulation outputs in graph 800). As will be appreciated by the skilled reader the method 200 has been able to successfully predict the speaker 10 response.

The nearfield vent, woofer and impedance traces in FIG. 9B (lines 812, 816 and 814 respectively) also closely track the simulated outputs shown in FIG. 9A in graph 800 (traces 802, 806 and 804 respectively), again supporting the accuracy of the simulations and lending confidence to future simulated optimizations using the method 200.

As a result of utilizing such a methodology, the inventors have been able to produce a transmission line speaker 10 that compares to a reference transmission line speaker 600 without acoustic foams 602 or acoustic wadding 602 to be incorporated in the design.

It will be appreciated that various modifications, changes and amendments may be made to the present disclosure without departing from the scope of the application.

### FEATURE REFERENCE TABLE

No. Feature
10 Speaker
12 Port
14 Transmission Line
20 Drive Unit
22 Drive Unit Mount
24 Drive Unit
26 Drive Unit Mount
30 Speaker Enclosure
31 Body
32 Top Wall
34 Bottom Wall
36 Front Wall
38 Rear Wall
40 First Side Wall
42 Second Side Wall
44 Fixture
46 Internal Wall
50 Acoustic Resonator
51 Chamber
52 Quarter Wave Resonator
54 Helmholtz Resonator
56 Orifice
57 Neck
58 Orifice
60 Recessed Portion
200 Flowchart
202 Step
204 Step
206 Step
208 Step
210 Step
300 Input
310 Computer
320 Output
400 Flowchart
402 Step
404 Step
406 Step
408 Step
500 Flowchart
502 Step
504 Step
506 Step
600 Reference transmission line speaker 600
602 Acoustic Foam/Acoustic Wadding
612 Port
614 Transmission Line
620 Drive Unit
624 Drive Unit
700 Graph
702 Foamless Transmission Line Speaker Trace
704 Reference Transmission Line Speaker Trace
710 Graph
712 Foamless Transmission Line Speaker Trace
714 Reference Transmission Line Speaker Trace
720 Graph
722 Foamless Transmission Line Speaker Trace
724 Reference Transmission Line Speaker Trace
730 Graph
732 Foamless Transmission Line Speaker Trace
734 Reference Transmission Line Speaker Trace
800 Graph
802 At Vent Exit
804 At 50 cm from vent
806 At Drive Unit
810 Graph
812 At Vent Exit
814 At 50 cm from vent
816 At Drive Unit

1. A transmission line speaker enclosure, the enclosure comprising:
a body having a first opening for fluid connection to a drive unit, a transmission line, a second opening for connection to a vent, and at least one acoustic resonator,
the first opening being fluidly connected to the second opening via the transmission line, and
the at least one acoustic resonator comprises a chamber, wherein the chamber is fluidly connected to the transmission line via an orifice.

2. An enclosure according to claim 1, wherein the orifice of the acoustic resonator is positioned at a location along the transmission line, wherein the position corresponds to a pressure mode of a tuning frequency of the acoustic resonator.

3. An enclosure according to claim 1, wherein the body comprises a plurality of acoustic resonators and each of the plurality of acoustic resonators comprise a chamber, and wherein the chamber of each acoustic resonator is fluidly connected to the transmission line via an orifice of the acoustic resonator.

4. An enclosure according to claim 3, wherein each orifice of the plurality of acoustic resonator is positioned at a different location along the transmission line, wherein each position corresponds to a pressure mode of a tuning frequency of the respective acoustic resonator.

5. An enclosure according to claim 3, wherein the number of acoustic resonators is 2 to 20; or 2 to 15; or 2 to 10; or 2 to 8; or 2 to 6.

6. An enclosure according to claim 3, wherein one or more of the acoustic resonators are located on a first side of the transmission line and the rest of the plurality of acoustic resonators are located on a second side of the transmission line.

7. An enclosure according to claim 1, wherein the at least one acoustic resonator is one of: a Helmholtz resonator or a quarter wave resonator or a tuned limp mass resonator, or a diaphragm resonator.

8. An enclosure according to claim 1, wherein the at least one acoustic resonator is configured to a tuning frequency of 50 to 550 Hz.

9. An enclosure according to claim 3, wherein the each of the acoustic resonators of the plurality of acoustic resonators is configured to a different tuning frequency.

10. An enclosure according to claim 9, wherein at least two of the tuning frequencies overlap to combine and enable broadband absorption.

11. An enclosure according to claim 1, wherein the chamber of the acoustic resonator is formed by a cavity of the body.

12. An enclosure according to claim 1, wherein the body has at least one planar side wall.

13. An enclosure according to claim 12, wherein the at least one planar side wall has a recessed portion for receipt of one of: electrical cabling and a gasket.

14. An enclosure according to claim 1, wherein the transition region between the transmission line and the orifice of the at least one acoustic resonator is rounded or tapered.

15. An enclosure according to claim 1, further comprising a drive unit mount and a vent; wherein the first opening is fluidly connected to the drive unit mount and the second opening is fluidly connected to the vent.

16. A transmission line speaker comprising the transmission line speaker enclosure of claim 1 and a drive unit.

17. The transmission line speaker of claim 16, wherein the transmission line does not contain an acoustic foam or acoustic wadding.

18. The transmission line speaker of claim 16, wherein the speaker enclosure does not contain an acoustic foam or acoustic wadding.

19. A method of manufacturing a transmission line speaker enclosure according to claim 1, comprising the steps of:
forming a body having a first opening for fluid connection to a drive unit, a transmission line, a second opening for connection to a vent, and at least one acoustic resonator, the first opening being fluidly connected to the second opening via the transmission line, and the at least one acoustic resonator comprises a chamber, wherein the chamber is fluidly connected to the transmission line via an orifice.

20. The method of claim 19, wherein the step of forming the body is undertaken by any one or combination of: a polymer extrusion process, a metal extrusion process, a 3D printing process, a casting process, a machining process, stacking a plurality of sheets.
